(19) United States
(12) Patent Application Publication
(10) Pub. No.: US 2019/0102622 A1
(43) Pub. Date: Apr. 4, 2019

(54) METHOD AND SYSTEM FOR MONITORING OIL WELL DEVELOPMENT AND OPERATIONS

(71) Applicant: Genscape Intangible Holding, Inc., Louisville, KY (US)

(72) Inventors: Josef Spalenka, Louisville, KY (US); Ben Chu, Houston, TX (US); Brent Sundheimer, Louisville, KY (US); Deirdre Alphenaar, Prospect, KY (US)

(21) Appl. No.: 16/146,031

(22) Filed: Sep. 28, 2018

Related U.S. Application Data
(60) Provisional application No. 62/565,493, filed on Sep. 29, 2017.

(51) Int. Cl. G06K 9/00; E21B 41/00; G06K 9/62

(52) U.S. Cl. CPC G06K 9/00637; G06K 9/6215; G06K 9/00771; E21B 41/00

(57) ABSTRACT

In a method and system for monitoring oil well development and operations, an area of interest is defined. Imagery of the area of interest is periodically received and analyzed to identify a cleared area of land, which confirms that construction of an oil well at a site has commenced. Additional imagery of the site is subsequently received and analyzed to identify one or more milestones associated with development of the oil well, including arrival of a drilling rig at the site, departure of the drilling rig from the site, completion of construction of the oil well, and building of production facilities at the site. Information about completion of the oil well and/or information about the status of the development of the oil well is then communicated to third-party market participants and other interested parties.

### CROSS-REFERENCE TO RELATED APPLICATIONS

The present application claims priority to U.S. Patent Application Ser. No. 62/565,493 filed on Sep. 29, 2017, which is incorporated herein by reference.

### BACKGROUND OF THE INVENTION

The present invention relates to monitoring oil well site development and operations.

As described in commonly assigned U.S. Pat. No. 8,717,434, which is incorporated herein by reference, liquid energy commodities, such as crude oil, comprise a multi-billion dollar economic market. These commodities are bought and sold by many parties, and as with any traded market, information about the traded commodities is very valuable to market participants. Specifically, the operations of facilities associated with the production, transportation, storage, and distribution of these commodities can have significant impacts on the price and availability of these commodities, making information about said operations valuable. Furthermore, such information generally is not disclosed publicly by the various component owners or operators, and access to said information is therefore limited.

One type of information that is of interest to those involved in the trading of liquid energy commodities is the status of development of oil wells, including oil wells in a particular region or oil wells of a particular owner/operator. As mentioned above, such information generally is not disclosed publicly by the owners/operators. Furthermore, in many oil-producing developing countries, to the extent any information about new oil well drilling activity is available at all, it is usually inadequate, error-prone, and/or incomplete. This is particularly true in “conflict countries,” i.e., developing countries with unstable governments and some degree of internal violent conflict.

### SUMMARY OF THE INVENTION

The present invention is a method and system for monitoring oil well development and operations.

In development of an oil well, there are a number of steps or milestones. Various of these steps or milestones can be identified and monitored via an analysis of satellite (or similar) imagery of the oil well site.

In an exemplary implementation of the present invention, the method commences by defining an area of interest. This area of interest may be defined by geographic coordinates or other criteria. Once the area of interest has been defined, the next step is to identify (or generate) a list of known or potential oil well locations in the area of interest. The list of such identified oil well locations is preferably stored in a database for subsequent monitoring.

For each oil well location that is identified, satellite (or similar) imagery is received and analyzed to determine if construction has commenced at the site of the oil well, i.e., to identify and confirm the presence of a cleared area of land. Various image processing techniques can be employed to identify this change (i.e., ground clearing and construction of an access road) across a series of received images in order to confirm the commencement of the construction of the oil well. For example, in one preferred image processing technique, a baseline image is first received and stored. Then, as new images are received, they are aligned and compared with the baseline image, and differences between the respective pixels in the image can be used to identify and confirm the presence of a cleared area of land.

Subsequent satellite (or similar) imagery is then analyzed to identify and confirm the arrival of a drilling rig at the site, and then the departure of the drilling rig from the site. Again, various image processing techniques can be employed to identify this change (i.e., arrival or departure of the drilling rig) across a series of received images. For example, with respect to the preferred image processing technique described above for confirmation that construction of an oil well has commenced, the same techniques can be applied to identify a drilling rig and associated equipment. For another example, objects on the drilling pad can be detected by using a machine learning model, such as a trained convolutional neural network, using satellite imagery from other similar sites.

After departure of the drilling rig from the site, subsequent satellite (or similar) imagery may be analyzed to determine if and when construction of the oil well has been completed. For example, with respect to determining if and when construction of the oil well has been completed, the presence of certain equipment (such as frac pumping trucks) can provide such confirmation. For another example, with respect to such a determination as to if and when construction of the oil well has been completed, short-wave infrared imagery collected at night may be used to identify natural gas flaring that is indicative of an oil well that is producing oil.

Subsequent satellite (or similar) imagery is then analyzed to determine if and when production facilities have been built at the site of the oil well. Again, various image processing techniques can be employed to identify this change (i.e., construction of production facilities at the site of the oil well) across a series of received images. For example, a machine learning model can be trained and applied as described above, but with images in the training set to be taken from other sites at times before and after installation of relevant production facilities.

The final result of the above-described analysis is an identification of a completed oil well (or wells). That information is then communicated to third-party market participants and other interested parties, e.g., third parties who would not ordinarily have ready access to such information. Of course, as information about the status of the development of each oil well is determined at each analysis step, that information can also be communicated to third-party market participants and other interested parties.

### DESCRIPTION OF THE DRAWINGS

FIG. 1 is a flow chart depicting the steps or milestones in the development of an oil well;

FIG. 2 is a flow chart depicting the general functionality of an exemplary implementation of the method of the present invention;

FIG. 3 is an exemplary image that shows a particular area of interest before any construction has commenced;

FIG. 4 is an exemplary image of the same area of interest as FIG. 3, but, in this image, the ground has been cleared, and an access road has been built;

FIG. 5 is an exemplary image result of a blob detection for identifying changes between the image in FIG. 3 and the image in FIG. 4;

FIG. 6 is an exemplary image of the same area of interest as FIGS. 3-4, but, in this image, a drilling rig and associated equipment can be identified at the site;

FIG. 7 is an exemplary image of the same area of interest as FIGS. 3-4 and 6, but, in this image, the drilling rig and associated equipment have departed the site; and

FIG. 8 is an exemplary image that illustrates nighttime flaring observations for two different nights in an area of interest.

### DETAILED DESCRIPTION OF THE INVENTION

The present invention is a method and system for monitoring oil well development and operations.

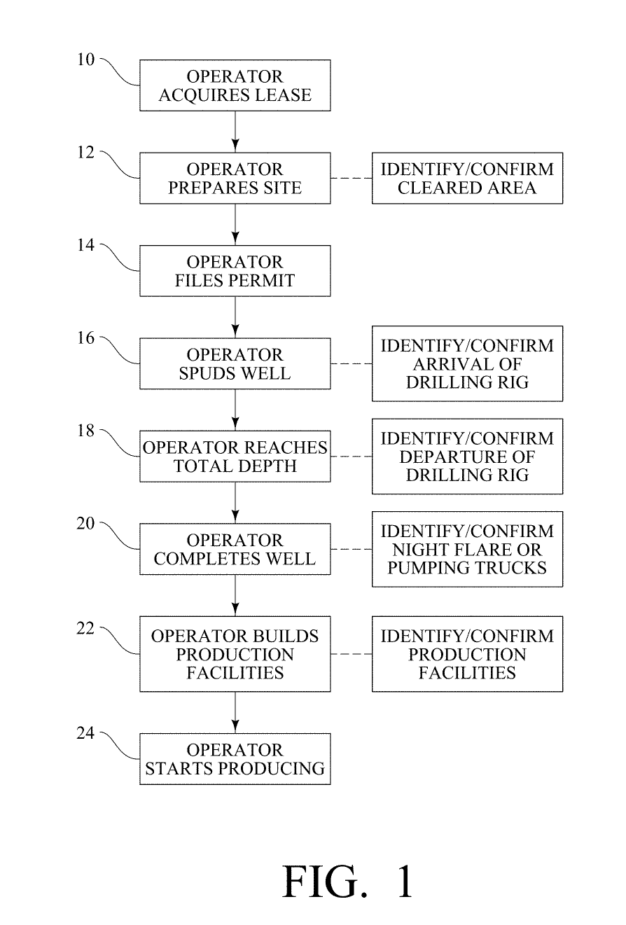

As illustrated in FIG. 1, in the development of an oil well, there are a number of steps or milestones, including: (i) operator acquires lease, as indicated by block 10, (ii) operator prepares site, as indicated by block 12; (iii) operator files permit, as indicated by block 14; (iv) operator spuds the well, which is the process of starting to drill a well, as indicated by block 16; (v) operator reaches total depth and finishes drilling, as indicated by block 18; (vi) operator completes well, as indicated by block 20; (vii) operator builds production facilities, as indicated by block 22; and (viii) operator starts producing, as indicated by block 24.

As also illustrated in FIG. 1, various of these steps or milestones can be identified and monitored via an analysis of satellite (or similar) imagery of the oil well site. Specifically, with respect to preparing the site, as indicated by block 12, imagery can be used to identify and confirm the presence of a cleared area of land, which is typically rectangular and is connected to an access road. With respect to spudding the well, as indicated by block 16, imagery can be used to identify and confirm the arrival of a drilling rig to the site. With respect to reaching total depth and finishing drilling, as indicated by block 18, imagery can be used identify and confirm the departure of the drilling rig from the site. With respect to completion of the well, as indicated by block 20, imagery can be used to identify and confirm the presence of a night flare, or such imagery can be used to identify and confirm the presence of frac pumping trucks. With respect to building production facilities, as indicated by block 22, imagery can be used to identify and confirm the installation and presence of such production facilities, including, but not limited to, oil and water tanks, gas shacks, and a separator unit.

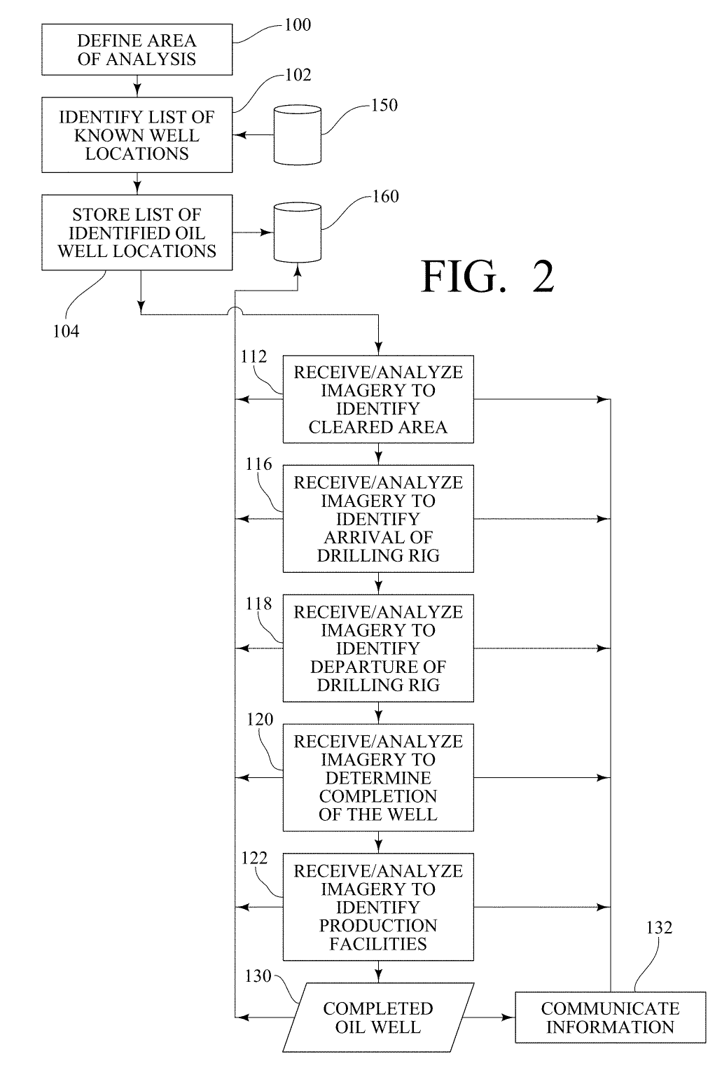

Referring now to FIG. 2, in an exemplary implementation of the present invention, the method commences by defining an area of interest, which is indicated by block 100 in FIG. 2. This area of interest may be defined by geographic coordinates or other criteria.

Referring still to FIG. 2, once the area of interest has been defined, the next step is to identify (or generate) a list of known or potential oil well locations in the area of interest, for example, by accessing a database 150 of state permit data, as indicated by block 102 in FIG. 2. The list of such identified oil well locations is preferably stored in a database 160 for subsequent monitoring, as indicated by block 104 in FIG. 2.

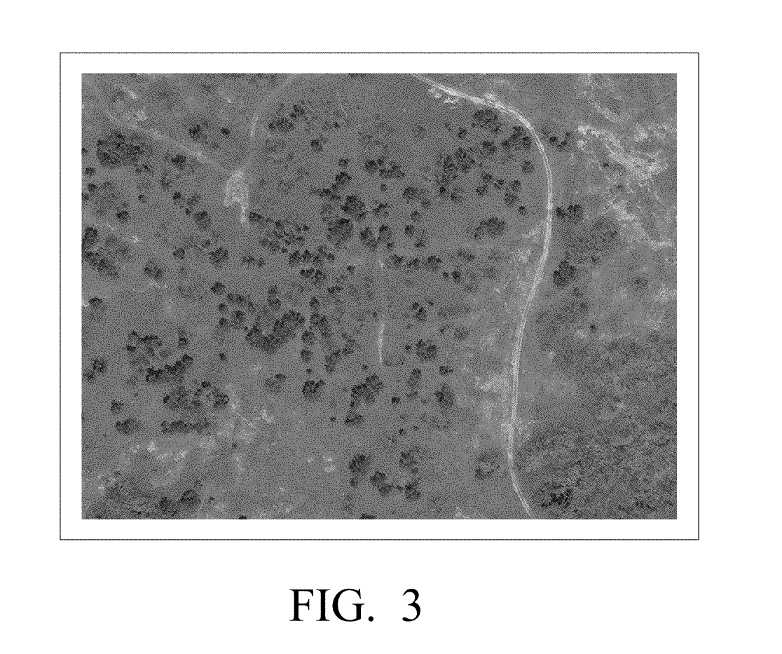

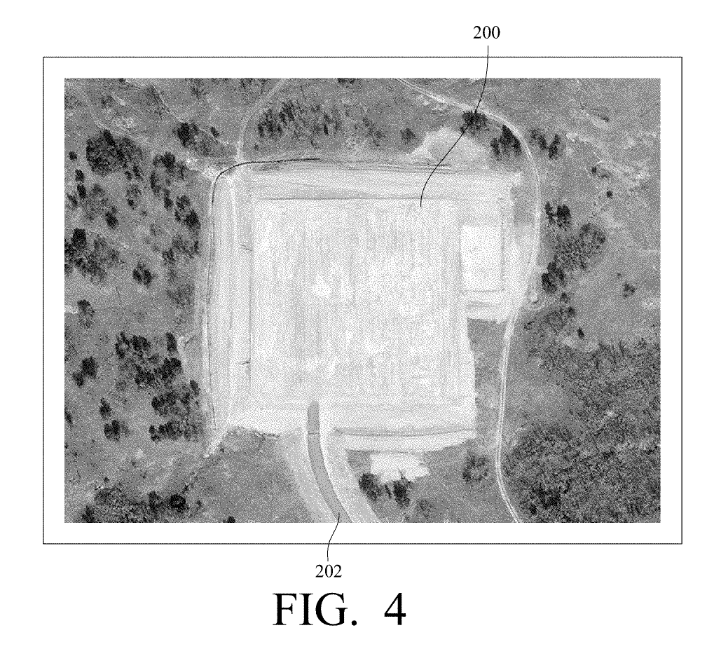

Referring still to FIG. 2, for each oil well location that is identified, satellite (or similar) imagery is received and analyzed to determine if construction has commenced at the site of the oil well, i.e., to identify and confirm the presence of a cleared area of land, as indicated by block 112 in FIG. 2. For example, FIG. 3 is an exemplary image that shows a particular area of interest before any construction has commenced. FIG. 4 is an exemplary image of the same area of interest, but, in this image, there is a cleared area of land 200, and an access road 202 has been built. This serves as confirmation that preparation of the site has commenced, and thus, construction of the oil well has commenced. Various image processing techniques can be employed to identify this change (i.e., ground clearing and construction of an access road) across a series of received images in order to confirm the commencement of the construction of the oil well.

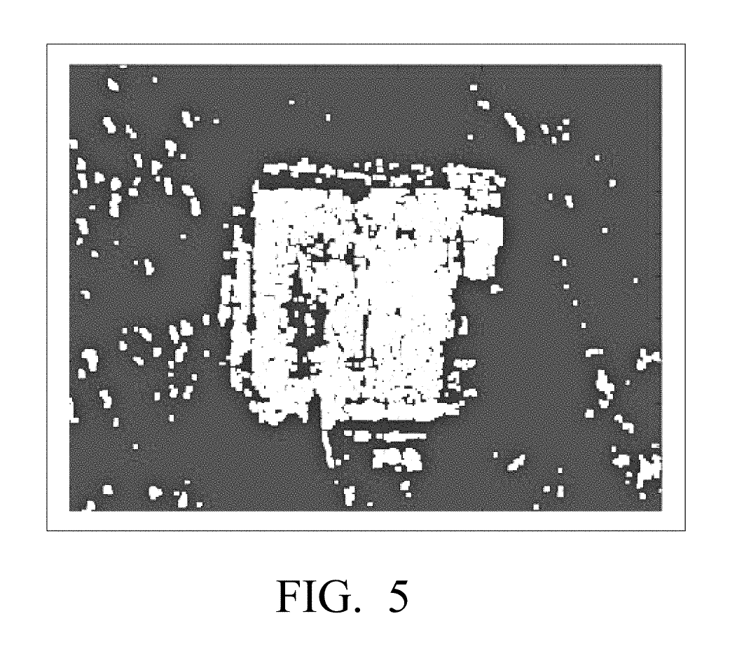

For example, in one preferred image processing technique, a baseline image is first received and stored. Then, as new images are received, the baseline image is aligned to each new image via geo-coordinates that are included in such images via metadata, including the minimum and maximum latitude and longitude boundaries. Once the images are aligned, a difference between the two images is calculated, where each aligned pixel is converted from having red, green, and blue channels into a color space which is comprised of a pixel intensity channel and two color channels. In this regard, there are a number of color spaces which can be used, but a preferred color space is the Lab color space, which mathematically describes all perceivable colors in the three dimensions: L for lightness, and a and b for the color opponents green-red and blue-yellow. Then, the Euclidean distance between each pixel in the color space is calculated. A threshold is determined beforehand based on the area being searched, and the image is thresholded for all of the pixels in the Euclidean distance, such that any pixels that are above the threshold are considered one, and any pixels that are below the threshold are considered a difference. This result can be noisy, so in order to find a large area change, blob detection is performed, such that all pixels which are one and are adjacent to another pixel which has a value of one are grouped together and considered “blobs.” An example of the result of such a blob detection, which is a binary image, is shown in FIG. 5. Each blob is then considered according to its dimensions. Any blob which has dimensions that are consistent with known dimensions of a drilling pad provides the confirmation that construction of the oil well has commenced.

Furthermore, in some cases, oil wells may not have been previously identified if and until an analysis of images of certain geographic locations results in the identification of ground clearing and construction of an access road at one or more sites. However, after such an identification of ground clearing and construction of an access road, the site can be subsequently monitored, e.g., by storing that site in the database 160 for subsequent monitoring.

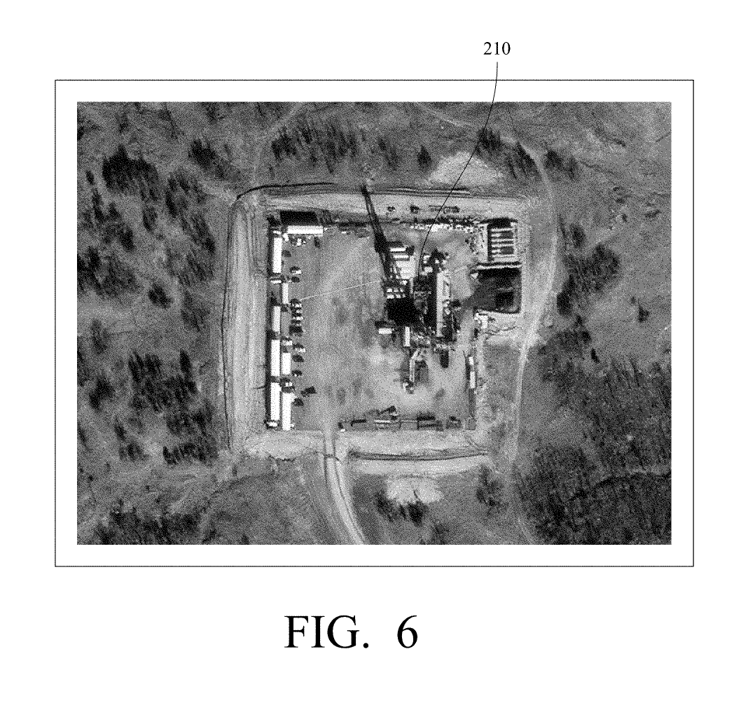

Referring again to FIG. 2, subsequent satellite (or similar) imagery is analyzed to identify and confirm the arrival of a drilling rig at the site, as indicated by block 116 in FIG. 2. FIG. 6 is an exemplary image of the same area of interest as FIGS. 3-4, but, in this image, a drilling rig 210 and associated equipment can be identified at the site. Again, various image processing techniques can be employed to identify this change (i.e., arrival of the drilling rig and associated equipment) across a series of received images.

For example, with respect to the preferred image processing technique described above for confirmation that construction of an oil well has commenced, the same techniques can be applied to identify a drilling rig and associated equipment. For another example, objects on the drilling pad can be detected by using a machine learning model, such as a trained convolutional neural network, using satellite imagery from other similar sites. These images are chosen using publicly available data during the appropriate time window, e.g., times after pad construction but before drilling to train the model for no drilling activity, and times after drilling has begun but before the rig leaves the site to train the machine learning model for drilling activity. Widely available software libraries can be used to build and train the models such as: TensorFlow™, which is an open source machine learning framework for high performance numerical computation available from Google LLC of Mountain View, Calif.; and/or Keras, which is a high-level neural networks application program interface (API) that runs on top of TensorFlow™ or other machine learning framework.

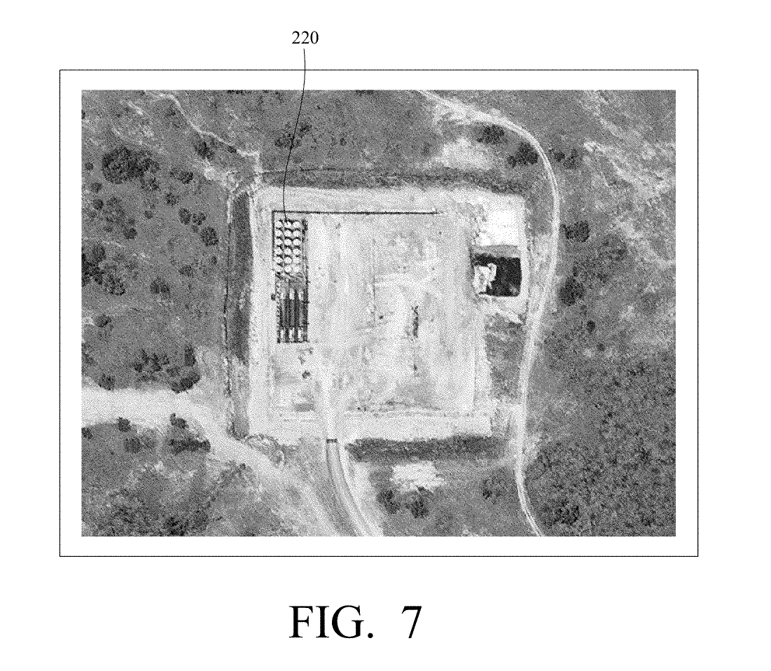

Referring again to FIG. 2, subsequent satellite (or similar) imagery is analyzed to identify and confirm departure of the drilling rig from the site, as indicated by block 118 in FIG. 2. FIG. 7 is an exemplary image of the same area of interest as FIGS. 3-4 and 6, but, in this image, the drilling rig and associated equipment have departed the site. The same analysis as in the previous step can be done, but with imagery corresponding to drilling taking place and the drilling rig having left the site, respectively.

Referring again to FIG. 2, after departure of the drilling rig from the site, subsequent satellite (or similar) imagery may be analyzed to determine if and when construction of the oil well has been completed, as indicated by blocks 120 in FIG. 2. For example, with respect to determining if and when construction of the oil well has been completed, the presence of certain equipment (such as frac pumping trucks) can provide such confirmation. For another example, with respect to such a determination as to if and when construction of the oil well has been completed, short-wave infrared imagery collected at night may be used. Specifically, upon drilling and completion of a new oil well, associated natural gas is typically flared (burned in a combustion flare stack), as, at the time of completion, there will be no infrastructure in place to capture and transport the associated gas. Flaring may be detected at night from short-wave infrared imagery, for example, by using publicly available third-party data from the VIIRS (Visible Infrared Imaging Radiometer Suite) satellite Nightfire data set provided daily by the National Oceanic and Atmospheric Administration (NOAA).

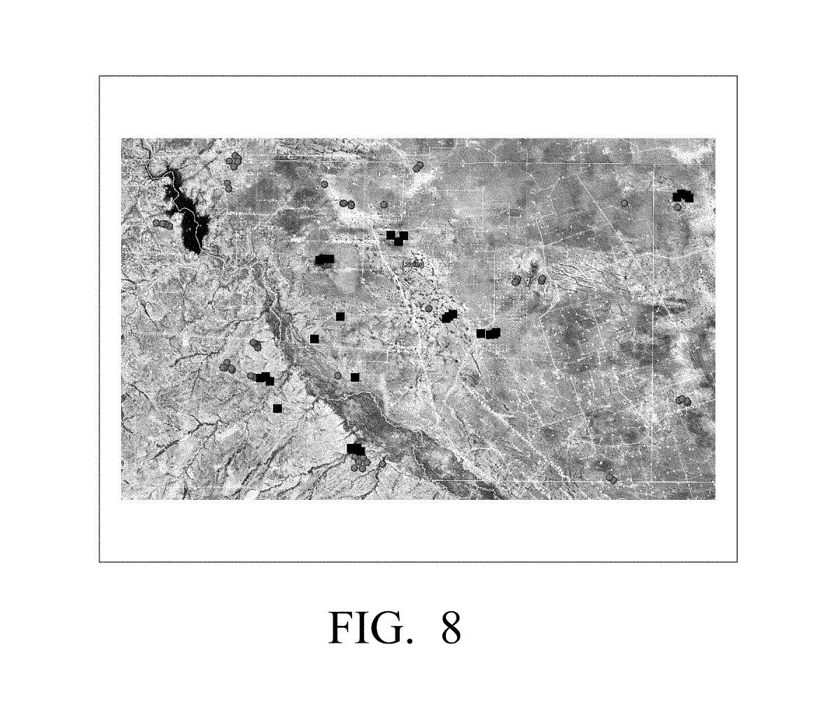

FIG. 8 illustrates nighttime flaring observations for two different nights in an area of interest, in this example, the Permian Basin in West Texas. In FIG. 8, the circle icons identify the locations of flares on a first night, while the square icons identify the locations of flares on a second night. The appearance of new flares in locations that have never flared in the past are an exemplary indicator of the location of newly completed wells.

Referring again to FIG. 2, subsequent satellite (or similar) imagery is then analyzed to determine if and when production facilities have been built at the site of the oil well, as indicated by block 122 in FIG. 2. With respect to such production facilities, FIG. 7 also indicates that a battery of tanks 220 has been installed in the northwest corner of the site; such tanks are one of the types of production facilities that may be visible in the imagery. In this regard, production facilities include any infrastructure necessary to extract oil from the well and into a pipeline or storage tank. Again, various image processing techniques can be employed to identify this change (i.e., the construction of production facilities at the site of the oil well) across a series of received images. For example, a machine learning model can be trained and applied as described above, but with images in the training set to be taken from other sites at times before and after installation of relevant production facilities.

Referring again to FIG. 2, the final result of the above-described analysis is an identification of a completed oil well (or wells), as indicated by output 130 in FIG. 2. That information is then communicated to third-party market participants and other interested parties, e.g., third parties who would not ordinarily have ready access to such information, as indicated by block 130 in FIG. 2. For example, such communication to third-party market participants could be achieved through electronic mail delivery and/or through export of the data to an access-controlled Internet web site, which market participants can access through a common Internet browser program. Of course, and as also illustrated in FIG. 2, as information about the status of the development of each oil well is determined at each analysis step, that information can also be communicated to third-party market participants and other interested parties. Additionally, and as also illustrated in FIG. 2, as information about the status of the development of each oil well is determined at each analysis step, that information can also be stored in the database 160 as part of the record of a particular site.

As an additional refinement, information derived from the above-described analysis can be combined with other sources of data to generate production forecasts for wells in a particular region or wells of a particular owner/operator, and then communicated to third-party market participants and other interested parties.

The above-described operational and analysis steps of this method are preferably achieved through the use of a digital computer program (i.e., computer-readable instructions executed by a processor of a computer) that includes appropriate modules for executing the requisite instructions (which are stored in a memory component of the computer). Thus, an exemplary system for monitoring oil well development in accordance with the present invention includes: (a) an imagery-receiving module for receiving imagery for an area of interest, which is then stored in a database; (b) an analysis module for analyzing the imagery to (i) identify an oil well location in the area of interest and/or (ii) identify one or more milestones associated with development of an oil well; and (c) a communications module for communicating information about the development of the oil well to an interested party.

One of ordinary skill in the art will recognize that additional embodiments and implementations are also possible without departing from the teachings of the present invention. This detailed description, and particularly the specific details of the exemplary embodiments and implementations disclosed therein, is given primarily for clarity of understanding, and no unnecessary limitations are to be understood therefrom, for modifications will become obvious to those skilled in the art upon reading this disclosure and may be made without departing from the spirit or scope of the invention.

What is claimed is:

1. A method for monitoring oil well development, comprising the steps of:
defining an area of interest;
identifying an oil well location in the area of interest;
receiving imagery of the oil well location;
analyzing the imagery to identify one or more milestones associated with development of an oil well;
communicating information about the development of the oil well to an interested party.

2. The method as recited in claim 1, wherein the imagery comprises satellite imagery of the area of interest.

3. A method for monitoring oil well development, comprising the steps of:
defining an area of interest;
periodically receiving imagery of the area of interest;
analyzing the imagery to identify a cleared area of land, which confirms that construction of an oil well at a site has commenced;
subsequently analyzing the imagery to identify and confirm arrival of a drilling rig at the site;
subsequently analyzing the imagery to identify and confirm departure of the drilling rig from the site;
subsequently analyzing the imagery to determine if and when construction of the oil well has been completed;
subsequently analyzing the imagery to determine if and when production facilities have been built at the site; and
communicating information about development of the oil well at the site to an interested party.

4. The method as recited in claim 3, wherein the imagery comprises satellite imagery of the area of interest.

5. The method as recited in claim 3, wherein the step of analyzing the imagery to identify the cleared area of land comprises the sub-steps of:
receiving and storing a baseline image;
receiving and aligning a subsequent image with the baseline image;
performing a blob detection to identity areas of difference between the subsequent image and the baseline image, resulting in a binary image; and
identifying a blob in the binary image with dimensions consistent with known dimensions of a drilling pad.

6. The method as recited in claim 3, wherein the step of analyzing the imagery to identify and confirm the arrival of the drilling rig at the site is facilitated through machine learning and based on imagery from other oil well sites.

7. The method as recited in claim 3, wherein the step of analyzing the imagery to identify and confirm the departure of the drilling rig from the site is facilitated through machine learning and based on imagery from other oil well sites.

8. The method as recited in claim 3, wherein the step of subsequently analyzing the imagery to determine if and when construction of the oil well has been completed comprises the sub-steps of:
receiving multiple infrared images; and
analyzing the multiple infrared images to identify flaring at the site.

9. A system for monitoring oil well development, comprising:
an imagery-receiving module for receiving imagery for an area of interest, which is then stored in a database;
an analysis module for analyzing the imagery to (i) identify an oil well location in the area of interest or (ii) identify one or more milestones associated with the development of an oil well in the area of interest; and
a communications module for communicating information about the development of the oil well to an interested party.
